(19) United States
(12) Patent Application Publication
(10) Pub. No.: US 2007/0118646 A1
(43) Pub. Date: May 24, 2007

(54) Preventing the installation of rootkits on a standalone computer

(75) Inventor: Paul A. Gassoway, Norwood, MA (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/244,014

(22) Filed: Oct. 4, 2005

(51) Int. Cl. G06F 15/173

(52) U.S. Cl. 709/225

(57) ABSTRACT

The present invention includes a system and method of preventing remote installation of software on a computer. The method may include preventing installation of software when a computer is operating in a normal mode and rebooting the computer into a safe mode wherein network connections of the computer are disabled. The method may also include allowing installation of the software while the computer is in the safe mode.

### TECHNICAL FIELD OF THE INVENTION

This invention relates generally to computer security and more specifically to preventing the installation of rootkits on a standalone computer.

### BACKGROUND

A rootkit is a malicious program that gives an unauthorized user root or access to a computer. Once installed on a computer, a rootkit may provide any user aware of the presence of the rootkit administrative access to the computer. Administrative access may allow the unauthorized user to access any of the functions of the computer, any information on the computer, or use the computer for other malicious activities.

A kernel level rootkit may include a portion of kernel level code. The kernel level code of the rootkit may actively mask the presence of the rootkit. The kernel level code is completely trusted by the computer and the kernel level rootkit may perform any functions at the kernel level or mask the presence of an associated user level code of the rootkit.

Rootkits may be installed on a computer by a person having physical access to the computer or by a person able to access the computer over a network. Once the person has gained access to the computer, an executable may be run to install the rootkit and the computer may be rebooted. Once rebooted the rootkit will be present on the computer and able to perform malicious activities and hide its presence.

### SUMMARY

Particular embodiments of the present invention may include a system and method of preventing remote installation of software on a computer. The method may include preventing installation of software when a computer is operating in a normal mode and rebooting the computer into a safe mode wherein network connections of the computer are disabled. The method may also include allowing installation of the software while the computer is in the safe mode.

Technical advantages of particular embodiments of the invention may include the ability to restrict unauthorized software installations on a computer by requiring the computer to request permission from a master computer prior to installing software. The master computer may include a pre-approved list. The client computer may poll the master computer requesting permission to install the software. If the software is on the pre-approved list of the master computer, the master computer may grant permission to the client computer to install the software. The client computer may then install the software.

Another technical advantage of particular embodiments of the present invention may include restricting software installation on a computer when the computer's network connections are active. In this embodiment, a computer may be required to reboot into a safe mode prior to installing software. When the computer reboots into safe mode, the network connections of the computer may be disabled. Once in safe mode with the network connections disabled, the software installation may proceed. After installing the software the computer may be rebooted into a normal mode. In this manner remote installation over the network of a malicious program may be prohibited.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates a network of computers operable to restrict software installations on a client computer in accordance with an embodiment of the present invention;

FIG. 2 illustrates communication between a client computer and a master computer in accordance with one embodiment of the present invention;

FIG. 3 is a flowchart illustrating a method of restricting unauthorized software installations on a client computer in accordance with a particular embodiment of the present invention;

FIG. 4 illustrates a computer configured to restrict remote software installations in accordance with a particular embodiment of the present invention; and

FIG. 5 is a flowchart illustrating a method of installing software on the computer of FIG. 4 in accordance with a particular embodiment of the present invention.

### DESCRIPTION OF EXAMPLE EMBODIMENTS

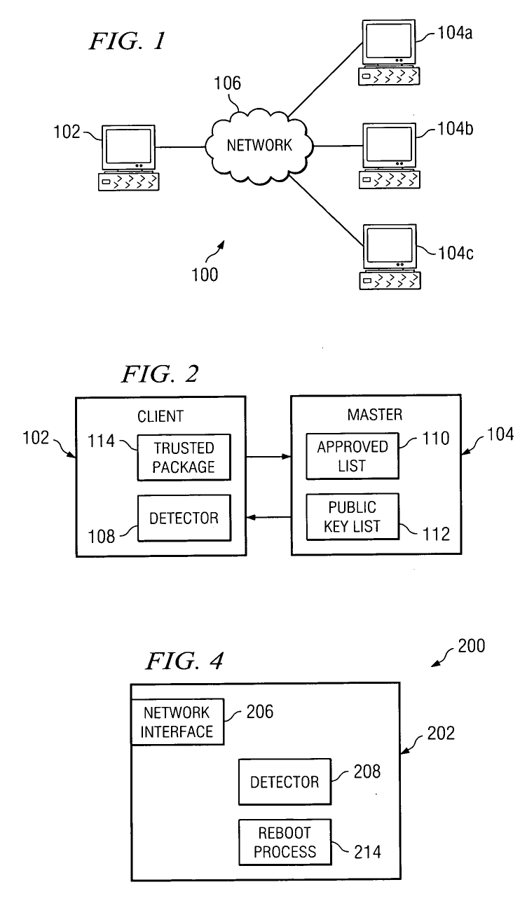

FIG. 1 illustrates a system 100 for preventing unauthorized software installations on a client computer 102. Client computer 102 may be coupled to one or more master computers 104 by network 106. No software may be installed on client computer 102 until permission has been granted by one or more of master computers 104. Client computer 102 may request permission to install particular software from one or more of master computers 104, and, if permission is granted, client computer 102 may proceed to install the software. In certain embodiments, client computer 102 may only request permission from one master computer 104, such as 104a, and may only receive permission from the single master computer 104. In other embodiments, more than one master computer 104a may be polled for permission by client computer 102. Each master computer 104 may being capable of vetoing the others, i.e., if any of the master computers 104 denies permission, client computer 102 will not install the software. This arrangement may be advantageous when there is a concern that one or more of master computers 104 may be corrupted and may be providing permission to install software on client computer 102 that is not authorized. Furthermore, a master computer 104 may be a dedicated machine with only an operating system and the necessary software running on it. In this way, vulnerabilities of software products other than the operating system may not be used to compromise a master computer 104. When multiple master computers 104 are utilized, each master computer 104 may utilize a different operating system, such that the same operating system vulnerability may not be used to corrupt all the master computers 104. System 100 could potentially be used to restrict any type of software installation on client computer 102, however, the discussion below will focus primarily on the ability to restrict installation of rootkits on client computer 102.

A rootkit is malicious software that may include both kernel and user level processes. When a rootkit is installed on a computer, such as client computer 102, the rootkit may allow an unauthorized user to gain root, or access, to the computer on which the rootkit is installed. A rootkit will often grant an unauthorized user administrative access to the computer. Once the unauthorized user has administrative access to the computer, the unauthorized user may perform any function with the computer that an administrator of the computer would be able to perform. A rootkit may thereby grant an unauthorized user access to confidential information stored on client computer 102 or accessible via a network, such as network 106, by client computer 102. The unauthorized user may also use client computer 102 for illegal or illicit activities. A kernel level rootkit may include a portion of kernel level code that may assist in masking the presence of the rootkit from detection by rootkit detectors that are either present on client computer 102 or scanning client computer 102 over a network. Once a kernel level rootkit has been installed on client computer 102, it may be very difficult to detect and/or remove the rootkit. For at least the above reasons, it is desirable to prevent the installation of rootkits on client computer 102.

A rootkit may be installed in the following manner. First, a malicious user utilizes an operating system vulnerability or social engineering to gain access to the target machine. The malicious user may then run a program that installs a rootkit device driver, replaces the appropriate files, wipes out any system log entries that reveal the install occurred, and reboots the machine. Once the machine boots up, the rootkit driver is present in kernel memory, and the rootkit is hidden from detection.

If a rootkit has not already been installed on a computer, then a detector can prevent the computer from being compromised by preventing rootkits from being installed. For example, to install a driver on a computer running the Windows operating system a registry key needs to be created under the HKLM\SYSTEM\CurrentControlSet\Services key. A rootkit detector can hook the registry calls, and prevent the creation of a new registry key. If the rootkit installer cannot create that key, the rootkit driver cannot be loaded into memory, and the rootkit cannot hide itself.

Legitimate software will also need to create registry keys during installation. To allow legitimate software to create registry keys, a detector driver may ask the permission of a remote computer (such as master computer 104) before allowing the creation of a new registry key. If master computer 104 allows the creation of the registry key, then the install would be allowed to continue normally. If master computer 104 does not allow the creation of the registry key, then the installation attempt could be logged, the appropriate people notified, and the attempt to install the rootkit device driver would fail.

A detector's device driver could also make it difficult to load a driver by hooking the device driver loader and only allowing approved drivers to load. When a driver is about to be loaded, the detector driver may intercept the call, read the device driver file, and calculate a hash. The detector driver may then send a request to master computer 104 including an identity of client computer 102, the user of client computer 102, and the hash of the device driver to be loaded. If master computer 104 refuses the request, the detector driver would refuse to allow the device driver to load. If master computer 104 accepts the request, then the device driver may load. The detector driver could also inform a remote system of system reboots so that any suspicious reboots could be logged by the remote system.

This system may not only protect against rootkits, but may also prevent users from installing non-malicious, but restricted software that could expose the system to security or support problems. For example, if a company has standardized on specific anti-virus software, this technique could prevent a user from installing different anti-virus software from another vendor.

FIG. 2 illustrates communication between client computer 102 and a single master computer 104. Client computer 102 may include a detector 108 that is able to detect an attempt to install software, such as a rootkit. When detector 108 detects an attempt to install software on client computer 102, detector 108 may poll master computer 104 to determine if the software is approved software. Master computer 104 may then determine if the software identification information transmitted by detector 108 matches approved software. If master computer 104 determines that the software is approved software, master computer 104 may transmit an electronic communication to detector 108 granting permission to install the software on client computer 102.

Master computer 104 may determine that the software is approved software in more than one way. First, master computer 104 may include an approved list 110. Approved list 110 is a listing of approved software compiled by an administrator of the network including client computer 102 and master computer 104. If master computer 104 finds the software on approved list 110, then master computer 104 may transmit permission to install the software to client computer 102.

Master computer 104 may also grant permission to proceed with an installation of software on client computer 102 by verifying the validity of a public key associated with a trusted package 114. Trusted package 114 may include approved software to be installed on client computer 102. Trusted package 114 may be created by an administrator of a network including client computer 102 and master computer 104. When client computer 102 receives trusted package 114, detector 108 may recognize trusted package 114 and inquire of master computer 104 whether or not the public key associated with trusted package 114 is a valid key. If the public key associated with trusted package 114 is found on the valid public key list 112 then master computer 104 may transmit a message to detector 108 that the public key associated with trusted package 114 is valid and that installation of the software included in trusted package 114 may proceed.

A trusted package 114 may be created by encrypting software or a software installation package using an encryption algorithm. In certain embodiments, trusted package 114 may be encrypted using an asymmetric encryption algorithm such as RSA. In this embodiment, the key used to encrypt and the key used to decrypt the trusted package are different and one may not be deduced from examination of the other. A private encryption key and a public decryption key pair may be created. The private key may be used to encrypt the software and then may be destroyed or kept secret. The public key may be transmitted along with the trusted package and may be used to decrypt the trusted package. Without the private key, the trusted package may not be modified or re-encrypted. Therefore, when a client computer 102 receives a trusted package 114, detector 108 may verify that the trusted package came from a network administrator by polling master computer 104 to determine if the public key associated with trusted package 114 is a valid key on public key list 112. If the public key associated with trusted package 114 is valid, then it is very unlikely that trusted package 114 has been modified since being created by the network administrator.

In particular embodiments, the trusted package may also include a Secure Hash Algorithm (SHA) hash. The SHA hash may be checked for corruption after decrypting trusted package 114. If trusted package 114 has been modified and re-encrypted the SHA hash may have become corrupted. If the SHA hash has become corrupted, client computer 102 may know that trusted package 114 may include software that is not safe to install.

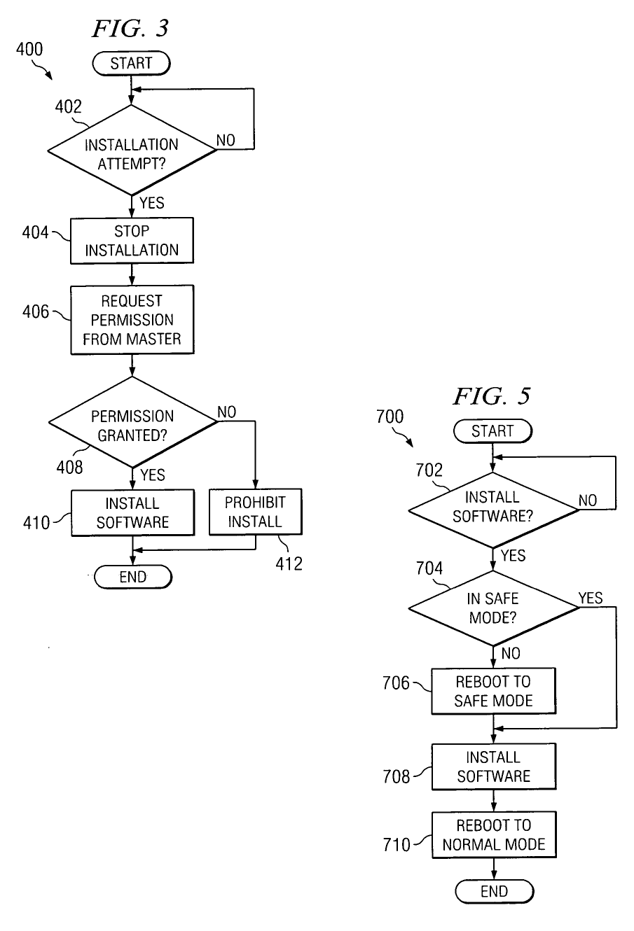

FIG. 3 is a flowchart 400 illustrating a method of preventing unauthorized software installations on a client computer 102. In step 402, a detector 108 may monitor client computer 102 for an installation attempt. When an installation attempt is recognized, detector 108 may halt the installation at step 404. At step 406 detector 108 may request permission from a master computer 104 to install the software. Master computer 104 may then either consult a list of approved software or a list of valid public keys to determine if the software that is being installed on client computer 102 is authorized. Master computer 104 will grant permission if the software is authorized and deny permission if the software is not authorized. At step 408 detector 108 determines if permission has been granted or not. If permission has been granted, then at step 410 detector 108 allows the installation of the software on client computer 102. If permission is not granted at step 408, the installation is prohibited at step 412.

When installation of software has been prohibited, several actions may occur in addition to denying the installation of the software. In particular embodiments, a network administrator or an administrator of client computer 102 may be notified of the failed installation attempt. Additionally, an administrator may be provided any information that is available about the software that was the subject of the installation attempt.

In another embodiment, when an installation is prohibited at step 412, client computer 102 may enter an ABEND (abnormal ending) state. Putting client computer 102 into an ABEND state will result in a memory dump and will render client computer 102 inaccessible to external communication networks. If the failed installation attempt was an attempt to install malicious software, such as a rootkit, an administrator may be able to reconstruct what was occurring as well as the software that was being installed. This may allow a signature of the software or rootkit that was the subject of the installation attempt to be created. This signature may be used to detect the software or rootkit on future installations or on other client computers 102. This embodiment may be particularly helpful because rootkit installers that realize they have been caught often erase the memory of the computer they were attempting to install the rootkit on to hide their illegal activities. Therefore, the memory dump may not only allow a signature to be created, but may also aid in discovering the identity of the rootkit installer.

To further increase the probability of catching a rootkit installer, detector 108 may include a stealth mode that allows detector 108 to actively hide itself from user mode processes. A rootkit installer is more likely to be caught by client computer 102 going into the ABEND state if the rootkit installer is not aware of detector 108. A signal from master computer 104 may detect a client computer's 102 detector 108 in stealth mode. Detector 108 would only respond to a signal if the source address were its master computer 104.

FIG. 4 illustrates a system 200 for prohibiting installation of unauthorized software on a stand alone computer without the assistance of a master computer. Computer 202 is illustrated with a network interface 206 with which computer 202 may connect to one or more networks including the Internet. Computer 202 also includes detector 208 which may be able to detect attempts to install software, and a reboot process 214 that may be able to reboot computer 202 into a safe mode.

Computer 202 may have two modes of operation, a normal mode and a safe mode. When computer 202 is operating in normal mode, detector 208 may detect any installation attempts and may automatically halt the installation of the software and deny the installation attempt. When computer 202 is operating in safe mode, detector 208 may be able to recognize that computer 202 is operating in safe mode and allow the installation of any software. When computer 202 is operating in normal mode, network interface 206 may be active and may allow an exchange of information between a network and computer 202. When computer 202 is operating in safe mode, network interface 206 may be disabled or otherwise isolated such that information may not pass between a network and computer 202.

A user of computer 202 may transition from normal mode to safe mode by activating a reboot process 214. Reboot process 214 may reboot computer 202 into safe mode when computer 202 is operating in normal mode, or reboot process 214 may reboot computer 202 into normal mode when computer 202 is operating in safe mode. When computer 202 is booting into safe mode, detector 208 may recognize that computer 202 is in safe mode and may disable network interface 206, or may otherwise disable network communications. In alternative embodiments, detector 208 may not directly disable network communication but network communication may be disabled as part of the functions of reboot process 214. Once computer 202 has been booted into safe mode and network communication has been disabled, detector 208 no longer prohibits software installations and software may be installed on computer 202 by a user of computer 202. By rebooting computer 202 into safe mode, remote installations of software over a network are prohibited.

In particular embodiments, reboot process 214 may also reset a startup procedure. The startup procedure may be reset to prohibit a malicious program from automatically executing an installation program when computer 202 is rebooted into safe mode. In other embodiments, all automatic installations may be prohibited in safe mode and only manual installations requiring input from a user of computer 202 may be allowed. In another embodiment, a startup procedure for booting into safe mode may be hard-coded so that a rootkit installer cannot change it.

FIG. 5 is a flowchart 700 illustrating a method of prohibiting remote installations of software on a computer 202. In step 702, a detector 208 may monitor computer 202 for an installation attempt. When an installation attempt has been detected, the detector determines whether or not computer 202 is in safe mode. If computer 202 is not in safe mode, the installation attempt may be rejected and a user of computer 202 may be notified of the installation attempt and be notified that in order to install software the user must reboot into safe mode. The user may reboot into safe mode at step 706. If computer 202 is in safe mode, either as determined at step 704 or as rebooted in step 706, then the software may be installed at step 708. Computer 202 may then be rebooted to normal mode at step 710.

Although the present invention has been described with several embodiments, a myriad of changes, variations, alterations, transformations, and modifications may be suggested to one skilled in the art and it is intended that the present invention encompass such changes, variations, alterations, transformations, and modifications as fall within the scope of the appended claims.

What is claimed is:

1. A method of preventing remote installation of software on a computer, comprising:
preventing installation of software when a computer is operating in a normal mode;
rebooting the computer into a safe mode wherein network connections of the computer are disabled; and
allowing installation of the software while the computer is in the safe mode.

2. The method of claim 1, further comprising rebooting the computer into the normal mode following installation of the software.

3. The method of claim 1, wherein installation of the software requires modification of kernel level code and kernel level code may not be modified when the computer is operating in the normal mode.

4. The method of claim 1, wherein a user of the computer starts a user level process that causes the computer to reboot into the safe mode.

5. The method of claim 4, wherein the user level process resets a start-up procedure of the computer prior to rebooting into the safe mode.

6. The method of claim 1, wherein a start-up procedure of the computer is hard coded into a memory of the computer and may not be modified.

7. The method of claim 1, wherein the computer includes a kernel level driver operable to recognize that the computer is in the safe mode and allow installation of the software.

8. The method of claim 1, wherein the computer includes a kernel level driver operable to hook into a start-up procedure of the computer and prevent automatic installation of the software.

9. The method of claim 1, wherein the computer includes a kernel level driver operable to prevent automatic installation of the software when the computer is in the safe mode.

10. The method of claim 1, wherein the computer includes a kernel level driver operable to prevent installation of the software when the computer is operating in the normal mode.

11. The method of claim 1, wherein the computer includes a kernel level driver operable to disable the network connections of the computer when the computer reboots into safe mode.

12. A system for preventing remote installation of software on a computer, comprising:
a kernel level driver operable to prevent installation of software on a computer when the computer is operating in a normal mode;
a user level process operable to reboot the computer into a safe mode wherein network connections of the computer are disabled; and
wherein the kernel level driver allows installation of the software while the computer is in the safe mode.

13. The system of claim 12, wherein the user level process is further operable to reboot the computer into the normal mode following installation of the software.

14. The system of claim 12, wherein installation of the software requires modification of kernel level code and kernel level code may not be modified when the computer is operating in the normal mode.

15. The system of claim 12, wherein a user of the computer starts the user level process.

16. The system of claim 15, wherein the user level process resets a start-up procedure of the computer prior to rebooting into the safe mode.

17. The system of claim 12, wherein a start-up procedure of the computer is hard coded into a memory of the computer and may not be modified.

18. The system of claim 12, wherein the kernel level driver is further operable to recognize that the computer is in the safe mode and allow installation of the software.

19. The system of claim 12, wherein the kernel level driver is further operable to hook into a start-up procedure of the computer and prevent automatic installation of the software.

20. The system of claim 12, wherein the kernel level driver is further operable to prevent automatic installation of the software when the computer is in the safe mode.

21. The system of claim 12, wherein the kernel level driver is further operable to prevent installation of the software when the computer is operating in the normal mode.

22. The system of claim 12, wherein the kernel level driver is further operable to disable the network connections of the computer when the computer reboots into safe mode.

23. Software embodied in a computer readable medium, the computer readable medium comprising code operable to:
prevent installation of software when a computer is operating in a normal mode;
reboot the computer into a safe mode wherein network connections of the computer are disabled; and
allow installation of the software while the computer is in the safe mode.

24. The medium of claim 23, wherein the code is further operable to reboot the computer into the normal mode following installation of the software.

25. The medium of claim 23, wherein installation of the software requires modification of kernel level code and kernel level code may not be modified when the computer is operating in the normal mode.

26. The medium of claim 23, wherein a user of the computer starts a user level process that causes the computer to reboot into the safe mode.

27. The medium of claim 26, wherein the user level process resets a start-up procedure of the computer prior to rebooting into the safe mode.

28. The medium of claim 23, wherein a start-up procedure of the computer is hard coded into a memory of the computer and may not be modified.

29. The medium of claim 23, wherein the computer includes a kernel level driver operable to recognize that the computer is in the safe mode and allow installation of the software.

30. The medium of claim 23, wherein the computer includes a kernel level driver operable to hook into a start-up procedure of the computer and prevent automatic installation of the software.

31. The medium of claim 23, wherein the computer includes a kernel level driver operable to prevent automatic installation of the software when the computer is in the safe mode.

32. The medium of claim 23, wherein the computer includes a kernel level driver operable to prevent installation of the software when the computer is operating in the normal mode.

33. The medium of claim 23, wherein the computer includes a kernel level driver operable to disable the network connections of the computer when the computer reboots into safe mode.
